(19) United States
(12) Patent Application Publication
(10) Pub. No.: US 2024/0337132 A1
(43) Pub. Date: Oct. 10, 2024

(54) Safe Key Park Brake

(71) Applicant: Mark Anthony Shine, Jacksonville, FL (US)

(72) Inventor: Mark Anthony Shine, Jacksonville, FL (US)

(21) Appl. No.: 18/297,595

(22) Filed: Apr. 7, 2023

(51) Int. Cl. E05B 13/10

(52) U.S. Cl. CPC E05B 13/105

(57) ABSTRACT

The Safe Key Park Brake (SKPB) knob is a lever with an integrated centered key locking system to prevent unauthorized operation of air brake vehicles. The SKPB is also designed as an anti-theft device. Air brake levers are always active and accessible whether the engine is on or off. In an emergency, such as assisting a passenger, with the SKPB in place the driver can safely assist without running the risk of the vehicle being exposed to danger. The SKPB is locked by a key that turns clockwise into the key shaft. This prevents the “push to release” function of the brake. To regain full operation, the key is turned counterclockwise. This allows full operation of the “push to release” function. The SKPB has a quick and easy-to-apply key locking feature. An alternative solution to securing a park brake is creating closure around the vehicle operator's area.

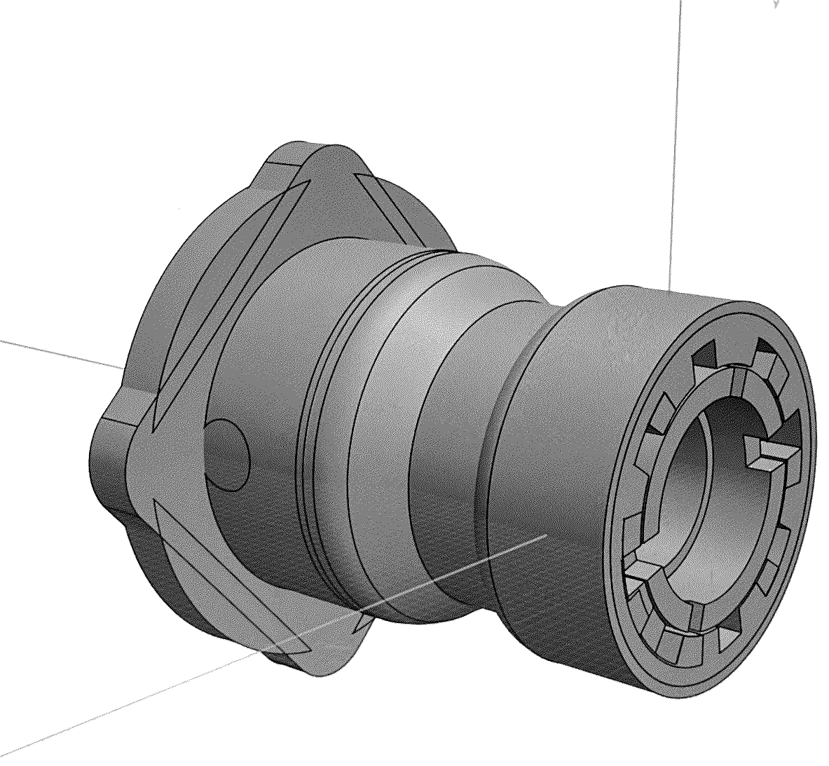

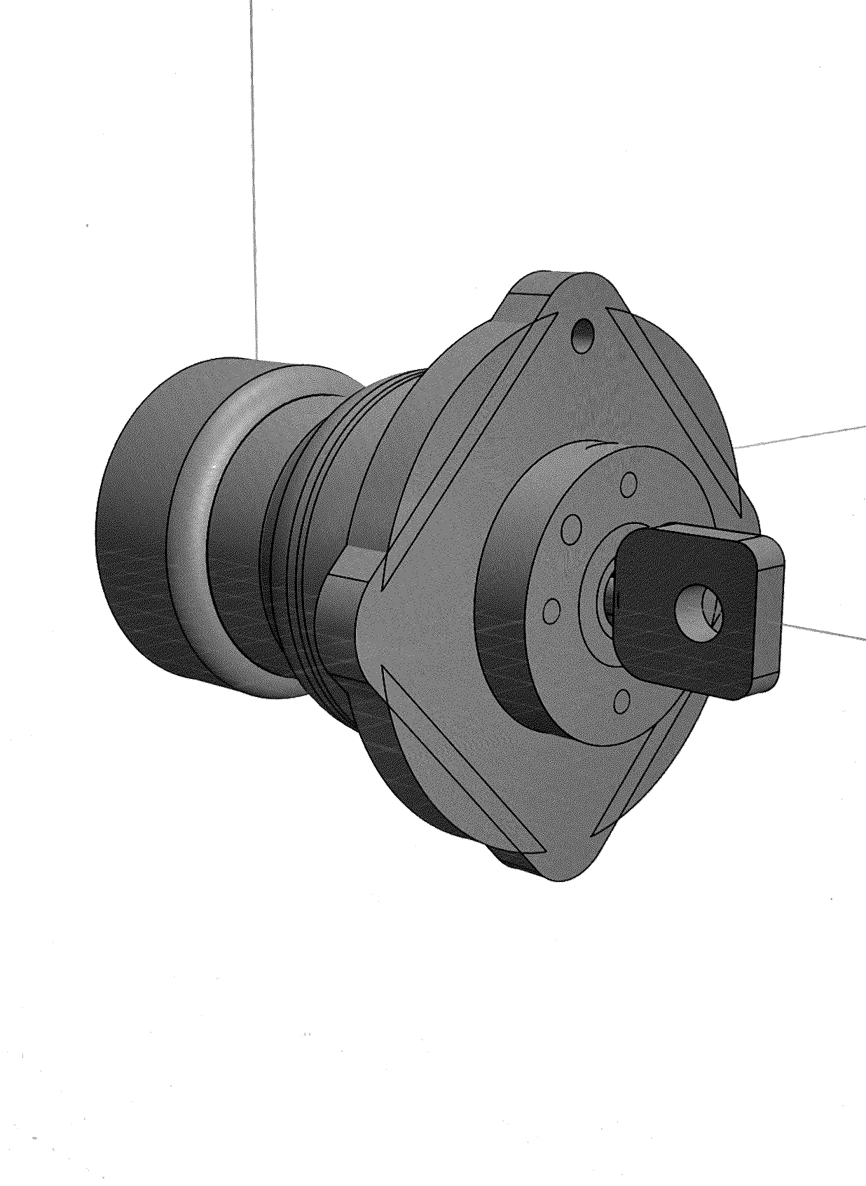

(1a) The Safe Key Park Brake (SKPB) is an air brake knob with an integrated centered key and lock system designed to control the access of the “push to release” function on the air brake valve rod for vehicles that use the air brake system.

(2a) The Safe Key Park Brake knob consists of a main casing, a key, and an outer and inner lock casement, a key shaft, two half-cylindrical jaws, lock pins, compression springs, a threaded piston and a lock nut. The outer and inner lock casements accommodate all of the locking components. The lock casements are mounted on the inside and outside of the top of the main casing with four screws. These screws pass through the main casing for securement. The two half-cylindrical jaws are connected to the key shaft, and are responsible for opening and retracting over the threaded piston to activate and deactivate the knob.

(3a) There is a threaded piston with a unique beveled shape on one end; this is mounted/screwed to the air brake valve rod. A lock nut with a similar but opposite beveled-shaped inner side equally matches the beveled-shaped threaded piston. Both beveled-shaped components, when combined, prevent the SKPB from unscrewing/dismounting without the key. The lock nut is mounted at the bottom of the main outer casing which encloses all the components and prevents the removal or dismantling of the SKPB knob.

All of the SKPB components are 3D printed. The main casing of the knob and the shims are printed from ABS (acrylonitrile butadiene styrene) plastic. The outer and inner lock casement, the key, the key shaft and lock pins are printed from brass nickel. The compression springs, the screws, the threaded beveled piston, the lock nut and the two half-cylindrical jaws are printed from stainless steel.

The outer lock casement is fitted on top of the main casing and secured with screws from the inside. The key shaft fitted with a compression spring on the inner tip is placed into the outer casement from inside of the main casing. The two half-cylindrical jaws fitted with compression springs are positioned on the inside of the main casing aligning with the key shaft. The inner casement is screwed to the outer casement covering the key shaft and the two half-cylindrical jaws with screws to connect/secure the inner and outer lock casement.

The threaded piston pushes into the main case with the beveled edge and threaded side facing toward the bottom of the main outer casing. The threaded beveled piston is the main component that holds the knob in place; this mounts/screws onto the air brake valve rod.

The lock nut fits onto the bottom of the main casing and consists of inward-facing beveled edges to complement the beveled edge of the threaded piston. The two beveled edges are equally opposite in design. The lock nut is turned clockwise to the lock position, and the shims are hammered into the vacant slots of the main casing to seal the lock nut and all components of the SKPB. The SKPB knob can be mounted/screwed onto the valve rod and the device is ready to operate.

1. The Safe Key Park Brake centered key locking knob is a claimed invention. As explained previously (1a), the Safe Key Park Brake is an air brake knob with an integrated centered key and lock system, designed to control the access of the “push to release” function of the air brake valve rod for vehicles that use the air brake system.

2. The lock mechanism and key design is a claimed invention. As explained previously (2a), the Safe Key Park Brake knob consists of a main casing, a key, and an outer and inner lock casement which accommodates all the locking components including the key shaft, two half-cylindrical jaws, lock pins and compression springs. The lock casement is mounted both inside and outside on the top of the main casing with screws that pass through the main casing for securement. The two half-cylindrical jaws are connected to the key shaft which opens and retracts to activate and deactivate the lock.

3. The non-removal design of the Safe Key Park Brake knob from the air brake valve rod without the key is a claimed invention. As explained previously (3a), there is a threaded piston with a unique beveled shape on one end which is mounted/screwed onto the valve rod of the air brake. A lock nut connected to the bottom of the main casing with a equally opposite beveled-shaped inner side matches the beveled-shaped threaded piston. When combined, they prevent the Safe Key Park Brake from unscrewing or dismounting without the key.
